(19) United States
(12) Patent Application Publication
(10) Pub. No.: US 2026/0348899 A1
(43) Pub. Date: Nov. 5, 2026

(54) BIOSENSOR AND STIRRED REACTOR

(71) Applicant: KYOTO UNIVERSITY, Kyoto (JP)

(72) Inventors: Keisei SOWA, Kyoto (JP); Sayaka Nishida, Kyoto (JP); Taiki Adachi, Kyoto (JP); Osamu Shirai, Kyoto (JP); Yuki Kitazumi, Kyoto (JP)

(21) Appl. No.: 19/708,792

(22) Filed: Jun. 15, 2026

Related U.S. Application Data
(63) Continuation of application No. PCT/JP2025/003273, filed on Jan. 31, 2025.

(30) Foreign Application Priority Data
Feb. 21, 2024 (JP) 2024-024806

(51) Int. Cl. G01N 27/327

(52) U.S. Cl. CPC G01N 27/3271; G01N 27/3276

(57) ABSTRACT

A biosensor (1) eliminates calibration of the output and can be used under a wide range of conditions. An insertion portion (10) placeable in a liquid sample includes a measurement compartment (13) that is fillable with the liquid sample when the insertion portion is placed in the liquid sample. An electrode (14) is mounted in the measurement compartment, with an en zyme (14z) immobilized on the electrode to be in contact with the liquid sample when the measurement compartment is filled with the liquid sample. The biosensor can thus eliminate the use of a permeability control layer and eliminate potential degradation or damage of the permeability control layer. The electrode mounted in the measurement compartment in the insertion portion is in contact with the liquid sample at rest in the measurement compartment. The biosensor thus eliminates calibration of the sensor output and can be used under a wide range of conditions.

### BACKGROUND OF INVENTION

### Field of the Invention

The present invention relates to a biosensor for measuring the concentration of an analyte in a liquid sample by converting the analyte to another substance with an enzyme immobilized on an electrode and by detecting the current value of a current generated at the electrode by the conversion, and relates to a stirred reactor including the biosensor.

### Background Art

A known biosensor measures the concentration of an analyte, such as a protein, in a liquid sample by converting the analyte to another substance with an enzyme immobilized on an electrode and by detecting the current value of a current generated at the electrode by the conversion.

The biosensor typically includes an electrode, an enzyme layer on the electrode, and a permeability control layer on the enzyme layer. An enzyme is immobilized on the enzyme layer to convert an analyte to another substance. The permeability control layer protects the enzyme layer and also selectively allows passage of an analyte in a liquid sample to supply the analyte to the enzyme layer. When a liquid sample is dropped onto the permeability control layer, the analyte in the liquid sample diffuses through the permeability control layer, reaches the enzyme layer, and is converted to another substance by the enzyme on the enzyme layer. The conversion transfers electrons between the enzyme and the analyte and generates a current at the electrode.

The enzyme can convert the analyte at a sufficiently high rate. The rate-determining process of the reaction of the enzyme to convert the analyte is supply of the analyte to the enzyme, and is thus diffusion of the analyte through the permeability control layer. The rate at which the analyte diffuses through the permeability control layer varies with the concentration of the analyte in the liquid sample in contact with the permeability control layer. The current value of the current generated at the electrode thus varies with the concentration of the analyte in the liquid sample. The concentration of the analyte in the liquid sample can thus be measured by detecting the current value of the current generated at the electrode (Patent Literature 1).

### CITATION LIST

### Patent Literature

Patent Literature 1: Japanese Unexamined Patent Application Publication No. 2000-081409 (paragraph 0003)

### SUMMARY OF INVENTION

### Technical Problem

However, such a known biosensor described above involves periodic calibration of the sensor output and also has largely restricted use conditions. After repeated use of the biosensor, the permeability control layer is contaminated with components of the liquid sample. Such contamination causes changes in the rate at which the analyte diffuses through the permeability control layer and thus causes changes in the current value at the electrode. Further, the permeability control layer may separate from the enzyme layer when the permeability control layer has an insufficient strength or undergoes swelling. To avoid such separation, the biosensor may have restricted use conditions.

In response to the above issues with the known biosensor, one or more aspects of the present invention are directed to a biosensor that eliminates calibration of the sensor output and can be used under a wide range of conditions.

### Solution to Problem

A biosensor according to one or more aspects of the present invention has the structure below. A biosensor measures a concentration of a predetermined analyte in a liquid sample by converting the analyte to a substance different from the analyte with an enzyme immobilized on an electrode and by detecting a current value of a current generated at the electrode by conversion of the analyte. The biosensor includes an insertion portion placeable in the liquid sample. The insertion portion includes a measurement compartment fillable with the liquid sample flowing into the measurement compartment when the insertion portion is placed in the liquid sample. The electrode is mounted in the measurement compartment, with the enzyme being immobilized on the electrode to be in contact with the liquid sample when the measurement compartment is filled with the liquid sample.

In a biosensor including no permeability control layer, the current value of the current generated at the electrode can be proportional to the concentration of the analyte in the liquid sample only when the liquid sample in contact with the biosensor remains at rest without a flow. The reasons for this will be described in detail later. In the biosensor according to the above aspect of the present invention, the insertion portion placeable in the liquid sample includes the measurement compartment. When the insertion portion is placed in the liquid sample, the measurement compartment is filled with the liquid sample. The electrode is mounted in the measurement compartment, with the enzyme being immobilized on the electrode to be in contact with the liquid sample when the measurement compartment is filled with the liquid sample.

The biosensor can thus eliminate the use of a permeability control layer and can eliminate potential contamination or separation of the permeability control layer. By mounting the electrode in the measurement compartment of the insertion portion, the space in the measurement compartment is less likely to be affected by a flow in the liquid sample when the insertion portion is placed in the liquid sample. Then the current value of a current generated at the electrode is proportional to the concentration of the analyte in the liquid sample. The biosensor eliminates calibration of the sensor output and can be used under a wide range of conditions.

In the biosensor according to the above aspect of the present invention, the measurement compartment may be cylindrical or prismatic and may be open at one end and closed at a bottom. The electrode may be mounted on a bottom surface of the cylindrical or prismatic measurement compartment.

This simplifies the structure of the measurement compartment and facilitates manufacture of the biosensor. Further, the electrode is mounted away from the position at which the measurement compartment opens to the outside. The liquid sample around the electrode is thus less likely to be affected by a flow in the liquid sample outside the measurement compartment. The output of the biosensor is thus less likely to undergo fluctuations caused by a flow in the liquid sample.

In the biosensor according to the above aspect of the present invention in which the measurement compartment is cylindrical or prismatic and closed at the bottom, the measurement compartment may be defined by a protruding wall protruding around the electrode and surrounding a space around the electrode.

This also simplifies the structure of the measurement compartment and facilitates manufacture of the biosensor. Further, the electrode is located away from the position at which the measurement compartment opens to the outside. The output of the biosensor is thus less likely to undergo fluctuations caused by a flow in the liquid sample.

In the biosensor according to the above aspect of the present invention in which the measurement compartment is cylindrical or prismatic and closed at the bottom, the measurement compartment may have a height greater than or equal to a diameter of a circle having a same area as the bottom surface of the cylindrical or prismatic measurement compartment.

This allows the electrode to be located at a sufficient distance from the position at which the measurement compartment opens to the outside. The output of the biosensor is thus less likely to undergo fluctuations caused by a flow in the liquid sample.

The biosensor according to any one of the above aspects of the present invention may be used particularly for monitoring or managing the progress of various reactions. One or more aspects of the present invention are thus also directed to a stirred reactor including the biosensor.

The stirred reactor according to the above aspect of the present invention can detect the concentration of the analyte stably and accurately while the liquid sample is stirred. This allows accurate and real-time monitoring of the progress of reactions, thus allowing appropriate management of various reactions.

### BRIEF DESCRIPTION OF THE DRAWINGS

FIG. 1 is an external perspective view of a biosensor 1 according to a first embodiment.

FIG. 2 is a diagram illustrating conversion of an analyte “a” in a liquid sample to another substance “b” with an enzyme 14z immobilized on an electrode 14.

FIG. 3 is a diagram illustrating formation of a spherical diffusion region 14s around the electrode 14 in the liquid sample.

FIG. 4 is a diagram illustrating an experimental method for examining the effect of a flow of the liquid sample on the sensor output using a biosensor 9 in a comparative example including no measurement compartment 13.

FIG. 5 is a graph illustrating the experimental results of the effect of a flow of the liquid sample on the sensor output examined using the biosensor 9 in the comparative example.

FIG. 6 is a diagram intuitively representing the reasons for which a flow of the liquid sample causes fluctuations of the sensor output of the biosensor 9 in the comparative example.

FIG. 7 is a diagram of the biosensor 1 according to the first embodiment, illustrating its distal end portion in cross section to show the interior of a measurement compartment 13.

FIG. 8 is a diagram illustrating an experimental method for examining the effect of a flow of the liquid sample on the sensor output using the biosensor 1 according to the first embodiment.

FIG. 9 is a graph illustrating the experimental results of the effect of a flow of the liquid sample on the sensor output examined using the biosensor 1 according to the first embodiment.

FIGS. 10A, 10B, and 10C are a graph and tables illustrating the experimental results of the effect of the shape of the measurement compartment 13 on the sensor output stability.

FIGS. 11A and 11B are diagrams of a biosensor 1 according to a first modification of the first embodiment.

FIGS. 12A and 12B are diagrams of a biosensor 1 according to a second modification of the first embodiment.

FIGS. 13A and 13B are diagrams of a biosensor 1 according to a third modification of the first embodiment.

FIGS. 14A and 14B are diagrams of a biosensor 1 according to a second embodiment.

FIG. 15 is a diagram of the biosensor 1 according to the second embodiment, intuitively representing the reasons for which the biosensor 1 is less likely to be affected by a flow of the liquid sample.

FIG. 16 is a diagram of a biosensor 1 according to a modification of a third embodiment.

FIG. 17 is a diagram of the biosensor 1 according to the third embodiment, intuitively representing the reasons for which the biosensor 1 is less likely to be affected by a flow of the liquid sample.

FIGS. 18A and 18B are diagrams of example stirred reactors each including the biosensor 1.

### DETAILED DESCRIPTION

### A. First Embodiment

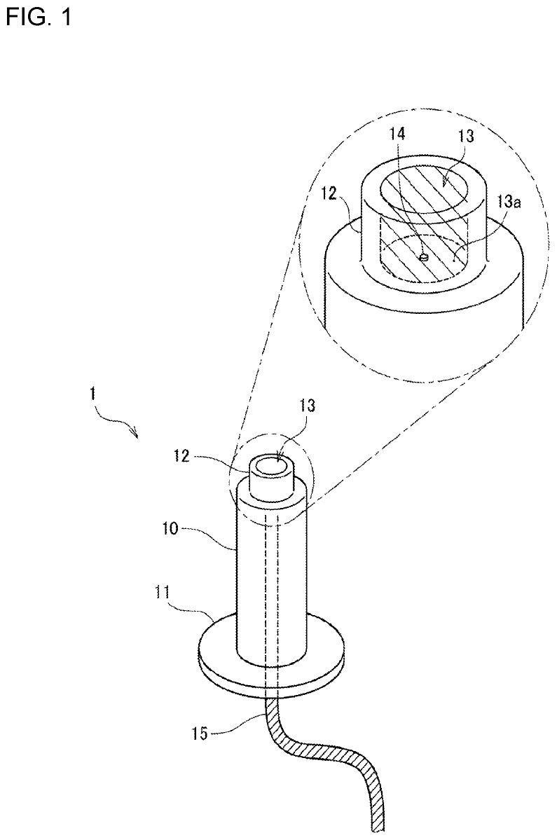

FIG. 1 is an external perspective view of a biosensor 1 according to a first embodiment. As illustrated, the biosensor 1 according to the first embodiment includes a cylindrical insertion portion 10. The insertion portion 10 has a flange 11 at the basal end and a short cylindrical protruding wall 12 at the distal end. The protruding wall 12 defines a cylindrical measurement compartment 13 that is open at one end. The measurement compartment 13 has a bottom surface 13a on which a small electrode 14 is mounted at the center. The electrode 14 is a microelectrode with a diameter (or a major axis of an ellipse) of about 0.1 mm or less. The measurement compartment 13 is also a small compartment with a diameter of about 5 mm or less in cross section. A thin electric wire formed from gold (not shown) extends from the electrode 14 and is connected to a lead wire 15 inside the insertion portion 10. The lead wire 15 extends out of the insertion portion 10 through the end face with the flange 11.

The electrode 14 and the measurement compartment 13 may be sized as appropriate to have substantially equal hydrodynamic quantities (specifically, Reynolds numbers) based on the environment in which the biosensor 1 is used (e.g., the flow velocity or the viscosity of the liquid to be measured). When the liquid to be measured flows at a low velocity or has a high viscosity, for example, the electrode 14 and the measurement compartment 13 may have larger sizes. The viscosity of the liquid may be, for example, as high as about 500 times the viscosity of water. In this case, the electrode 14 may have a diameter of about 50 mm, and the measurement compartment 13 may also have a diameter of about 50 mm in cross section.

The biosensor 1 according to the first embodiment is used with the distal end of the insertion portion 10 placed in a liquid sample. When the distal end of the insertion portion 10 is placed in the liquid sample, the liquid sample flows into the measurement compartment 13 through the open end and fills the measurement compartment 13. This causes the electrode 14 to be exposed to the liquid sample. The open end of the measurement compartment 13 is a connection portion between the measurement compartment 13 and the outside, and may be hereafter referred to as a connection port. An enzyme is immobilized on the electrode 14 to convert an analyte in the liquid sample to another substance. The conversion transfers electrons between the enzyme and the analyte and generates a current at the electrode 14. The enzyme immobilized on the electrode 14 may be a direct electron transfer enzyme that allows direct transfer of electrons to and from the electrode 14 without using an intermediate substance called a mediator. The utilization of such the enzyme allows the electron transfer between the enzyme and the analyte to correspond directly to that between the electrode 14 and the analyte. For example, the enzyme may selectively transfer electrons to and from oxygen, glucose, lactic acid, an amino acid (particularly glutamic acid), ammonia, or carbon dioxide. Examples of such enzymes include fructose dehydrogenases, multicopper oxidases, glucose dehydrogenases, glucose oxidases, pyranose dehydrogenases, ferredoxin-NADP+ reductases, cellobiose dehydrogenases, gluconate dehydrogenases, succinate dehydrogenases, histamine dehydrogenases, lactate dehydrogenases, alcohol dehydrogenases, aldehyde dehydrogenases, cytochromes P450, peroxidases, xanthine dehydrogenases, xanthine oxidases, sulfite oxidases, sulfite dehydrogenases, formate dehydrogenases, nitrogenases, nitrate reductases, carbon monoxide dehydrogenases, hydrogenases, galactose oxidases, and nitrous oxide reductases.

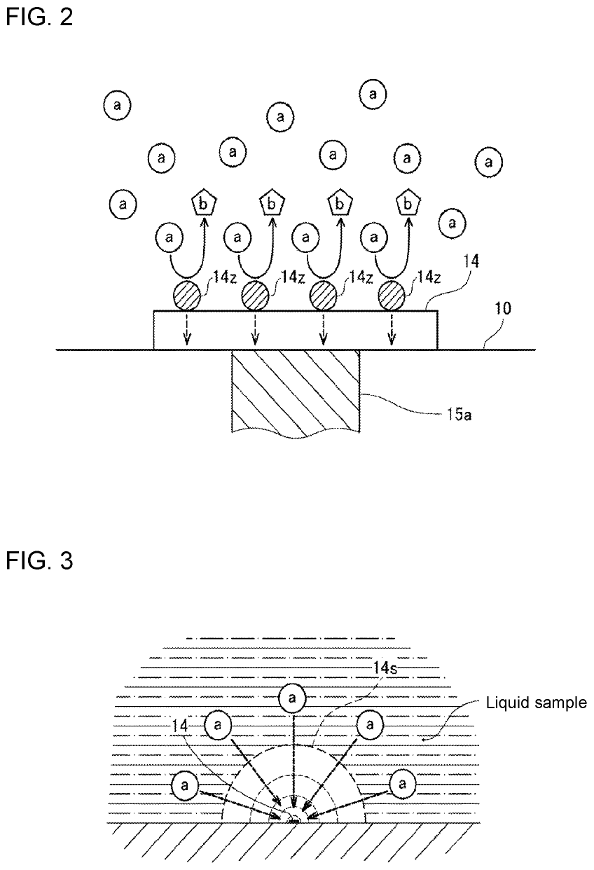

FIG. 2 is a diagram illustrating conversion of an analyte in a liquid sample to another substance with an enzyme 14z immobilized on the electrode 14. In FIG. 2, the enzyme 14z converts an analyte “a” in the liquid sample to another substance “b”. In the example shown in FIG. 2, the conversion transfers electrons from the analyte “a” to the electrode 14. The conversion can also transfer electrons to the analyte “a” from the electrode 14. The electrode 14 is connected to the thin electric wire 15a formed from gold, and the electric wire 15a is connected to the lead wire 15 (refer to FIG. 1).

A typical biosensor includes a permeability control layer on the enzyme immobilized on the electrode. The analyte in the liquid sample diffuses through the permeability control layer and is then converted by the enzyme. The rate at which the analyte diffuses through the permeability control layer is proportional to the concentration of the analyte in the liquid sample (hereafter also referred to as a substrate concentration of the analyte). The rate at which the analyte is supplied to the enzyme is determined by the concentration of the analyte, which thus determines the current value of a current generated at the electrode. The concentration of the analyte in the liquid sample is thus measured by detecting the current value at the electrode.

In contrast, the biosensor 1 according to the first embodiment includes no permeability control layer, with the enzyme 14z on the electrode 14 directly exposed to the liquid sample (refer to FIG. 2). In the biosensor 1 according to the first embodiment, the enzyme 14z immobilized on the electrode 14 can convert the analyte “a” at a sufficiently high rate. This causes formation of a spherical region around the electrode 14 in the liquid sample in which the concentration of the analyte “a” decreases toward the electrode 14 and is 0% at the position of the electrode 14. The biosensor 1 according to the first embodiment can thus eliminate the use of a permeability control layer. The reasons for this will be described below. The spherical region, in which the analyte “a” diffuses toward the electrode 14, is hereafter referred to as a diffusion region 14s.

FIG. 3 is a diagram illustrating formation of the spherical diffusion region 14s around the electrode 14 in the liquid sample. As described above, the enzyme 14z on the electrode 14 can convert the analyte “a” at a sufficiently high rate, and thus the concentration of the analyte “a” in the liquid sample is 0% at the position of the electrode 14. The region in which the concentration of the analyte “a” is 0% then receives the analyte “a” from its adjacent region by molecular diffusion. This reduces the concentration of the analyte “a” in the region that has supplied the analyte “a”, and thus causes this region to receive the analyte “a” from a further outer region by molecular diffusion. This further reduces the concentration of the analyte “a” in this outer region, and thus causes the region to receive the analyte “a” from a still further outer region. Regions farther from the center, which supply a larger amount of the analyte “a” to inner regions, have lower concentrations of the analyte “a”. In the spherical diffusion region 14s formed in the liquid sample, the concentration of the analyte “a” is thus 0% at the electrode 14 and varies to a substrate concentration “c” around the electrode 14.

In the diffusion region 14s centered at the electrode 14, the rate at which the analyte “a” in the liquid sample is supplied to the electrode 14 depends on the rate at which the analyte “a” diffuses in the diffusion region 14s by molecular diffusion. In a typical biosensor, as described above, the rate at which the analyte is supplied to the enzyme on the electrode is determined by the rate at which the analyte diffuses through the permeability control layer. In the biosensor 1 according to the first embodiment, in contrast, the rate at which the analyte “a” is supplied to the enzyme 14z is determined by the rate at which the analyte “a” in the liquid sample diffuses in the diffusion region 14s by molecular diffusion. In other words, the biosensor 1 according to the first embodiment replaces, with the diffusion region 14s, the permeability control layer found in any known typical biosensor. The permeability control layer, which may be degraded or damaged, involves calibration of the biosensor output after repeated use and also causes largely restricted use conditions. Replacing the permeability control layer with the diffusion region 14s eliminates calibration and also eliminates large restrictions on the use conditions.

When the spherical diffusion region 14s shown in FIG. 3 is formed, the analyte “a” in the liquid sample diffuses to the electrode 14 in the diffusion region 14s by molecular diffusion at a rate “v” calculated using the formula below.

v=4·Kd·c/(π·r)

In this formula, Kd is the diffusion coefficient of the analyte “a”, “c” is the substrate concentration of the analyte “a”, and “r” is the radius of the electrode 14.

When the spherical diffusion region 14s shown in FIG. 3 is formed, a critical current density “j” generated by conversion of the analyte “a” with the enzyme 14z is calculated using the formula below.

j=4·n·F·Kd·c/(π·r)

In this formula, “n” is the number of electrons generated by converting 1 molecule of the analyte “a”, and “F” is the Faraday constant. The Faraday constant F is a fixed value. The number “n” of electrons is a physical property value of the analyte “a”. The diffusion coefficient Kd is a physical property value determined by the combination of the liquid sample and the analyte “a”. When the combination of the liquid sample and the analyte “a” and the radius “r” of the electrode 14 are determined, the critical current density “j” that is proportional to the substrate concentration “c” of the analyte “a” is determined. This principle suggests that the biosensor 1 can eliminate calibration.

To form the spherical diffusion region 14s shown in FIG. 3, the liquid sample around the electrode 14 is to be at rest. With a flow in the liquid sample around the electrode 14, the critical current density “j” may not be proportional to the substrate concentration “c” of the analyte “a”. To confirm this, the experiments described below were conducted.

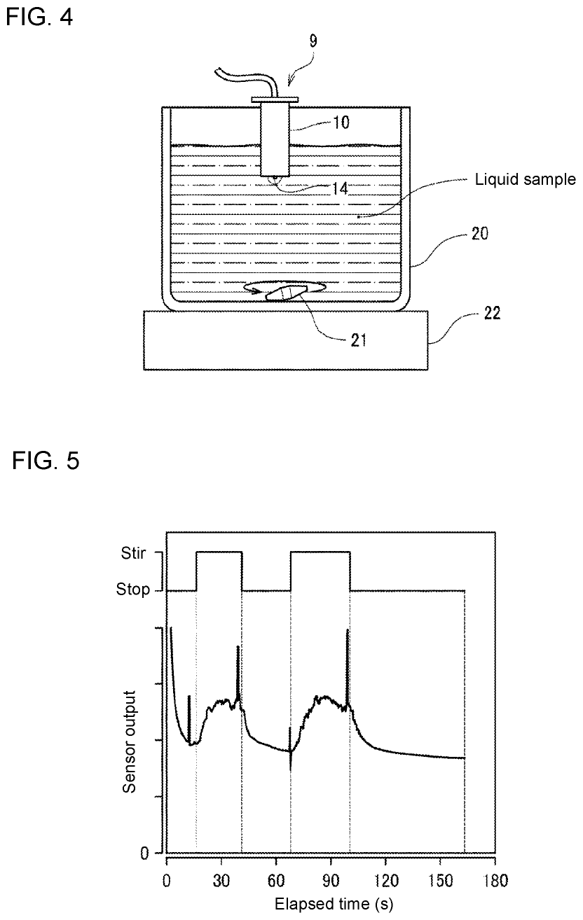

FIG. 4 is a diagram illustrating an experimental method for examining the effect of a flow of the liquid sample on the biosensor output. As shown in FIG. 4, a container 20 such as a beaker is placed on a stirrer 22, with the liquid sample and a rotor 21 in the container 20. A biosensor 9 in a comparative example including no measurement compartment 13, unlike the biosensor 1 according to the first embodiment shown in FIG. 1, is prepared. The output of the biosensor 9 in the comparative example was measured with its distal end portion placed in the liquid sample while stirring of the liquid sample with the stirrer 22 was performed or stopped.

FIG. 5 is a graph illustrating the obtained experimental results. In the example shown in FIG. 5, the biosensor 9 is placed into the liquid sample while the stirrer 22 is inactive. As shown in FIG. 5, the sensor output is high immediately after the biosensor 9 is placed into the liquid sample, and decreases rapidly with time. About 15 seconds later, the sensor output substantially stabilizes. Such changes in the sensor output may be associated with the process of formation of the spherical diffusion region 14s around the electrode 14 that occurs when the electrode 14 in the biosensor 9 converts the analyte “a” in the liquid sample.

When the rotor 21 is rotated using the stirrer 22 about 15 seconds after the biosensor 9 is placed into the liquid sample, the liquid sample in a lower portion of the container 20 starts to be stirred first. The liquid movement spreads upward, causing stirring of the liquid sample in an upper portion of the container 20. The sensor output increases rapidly slightly after the start of stirring with the stirrer 22, and then continues fluctuating after the increase. The increased sensor output is about 1.5 times the stable value obtained before the start of stirring.

When the stirrer 22 is deactivated about 25 seconds after the start of stirring (about 40 seconds after the biosensor 9 is placed into the liquid sample), the sensor output decreases rapidly. About 30 seconds later, the sensor output stabilizes at substantially the same value obtained before the start of stirring. Although the stabilization of the output takes about 15 seconds after the biosensor 9 is placed into the liquid sample, the stabilization of the output takes about two times longer after the active stirrer 22 is deactivated. This may result from a continuing swirl of the liquid sample in the container 20 for some time after the stirrer 22 is deactivated.

After the stirrer 22 is deactivated, stirring is started again upon stabilization of the sensor output (about 40 seconds after the biosensor 9 is placed into the liquid sample). The sensor output increases rapidly slightly after the start of stirring and then continues fluctuating at the increased levels, in the same manner as when stirring is started as described above. When the stirrer 22 is deactivated after that, the sensor output decreases rapidly and then substantially stabilizes about 30 seconds later, in the same manner as when stirring is stopped as described above.

Thus, the output of the biosensor 9 is easily affected by a flow of the liquid sample. In the above experiments, the sensor output increases by about 1.5 times in response to a flow in the liquid sample. The output of the biosensor 9 is thus not proportional to the substrate concentration “c” of the analyte “a” in a flowing liquid sample. This may result from disturbance of the spherical diffusion region 14s caused by a flow of the liquid sample. With no flow in the liquid sample, the concentration of the analyte “a” in the liquid sample outside the diffusion region 14s is the substrate concentration “c”. Inside the diffusion region 14s, the concentration of the analyte “a” decreases toward the electrode 14 and is zero at the electrode 1 4 at the center. With a flow in the liquid sample, however, the liquid sample at the substrate concentration “c” outside the diffusion region 14s may enter the diffusion region 14s toward the electrode 14, accelerating diffusion of the analyte “a” toward the electrode 14 in such a region.

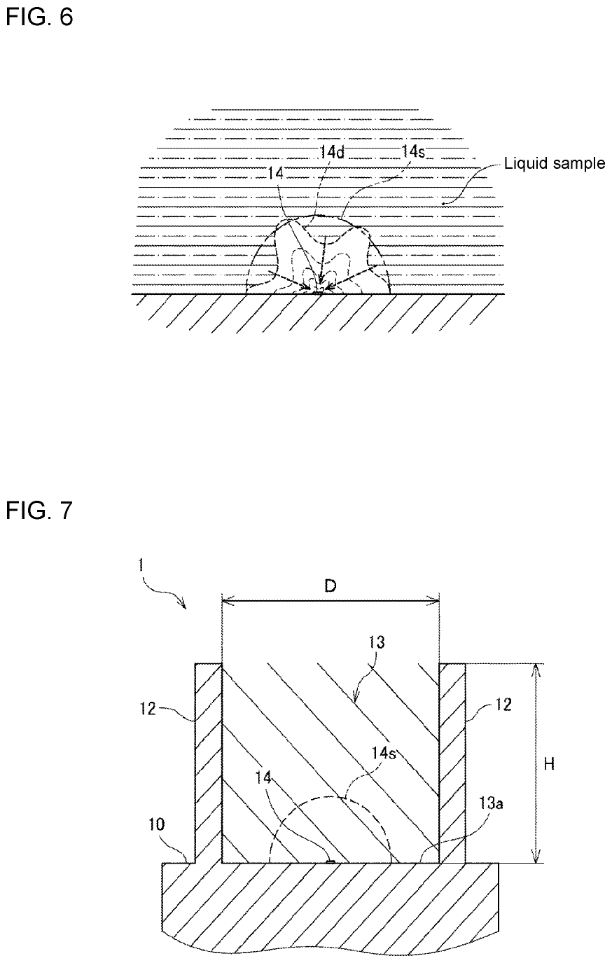

For intuitive understanding, the above phenomenon can be represented as the spherical diffusion region 14s deformed by a flow in the liquid sample as shown in FIG. 6. With no flow in the liquid sample, the spherical diffusion region 14s is formed as indicated by the dot-dash line in the figure. With a flow in the liquid sample, the spherical diffusion region 14s is deformed as indicated by the dashed line. The region resulting from deformation of the diffusion region 14s is hereafter referred to as a deformed diffusion region 14d. Outside the deformed diffusion region 14d, the concentration of the analyte “a” in the liquid sample is the substrate concentration “c”. Inside the deformed diffusion region 14d, the concentration of the analyte “a” gradually decreases toward the electrode 14 and is zero at the electrode 14. The deformed diffusion region 14d includes portions deformed inward with respect to the spherical diffusion region 14s. In these portions, the diffusion of the analyte “a” toward the electrode 14 is accelerated as indicated by the dashed arrows in FIG. 6. With the shape of the deformed diffusion region 14d changing constantly, the rate at which the analyte “a” diffuses to the electrode 14 also changes constantly. Such changes may correspond to the constant fluctuations in the output of the biosensor 9 during stirring in the experimental results shown in FIG. 5.

Based on the above discussion, the biosensor 1 according to the first embodiment includes the measurement compartment 13 at the distal end of the insertion portion 10, with the electrode 14 mounted in the measurement compartment 13 (refer to FIG. 1). Although the measurement compartment 13 is located at the distal end of the insertion portion 10 in FIG. 1, the measurement compartment 13 may be located on a side surface of the insertion portion 10. The measurement compartment 13 is cylindrical in this example, but may be, for example, prismatic.

FIG. 7 is a diagram of the biosensor 1 according to the first embodiment, illustrating its distal end portion in cross section to show the interior of the measurement compartment 13. The cylindrical protruding wall 12 protrudes from the distal end of the insertion portion 10 and defines the measurement compartment 13. The measurement compartment 13 is cylindrical with one end closed and the other end open. The measurement compartment 13 includes the electrode 14 mounted at the center of the bottom surface 13a that is the closed end face. When the distal end of the biosensor 1 according to the first embodiment is placed in the liquid sample, the measurement compartment 13 is filled with the liquid sample, and the spherical diffusion region 14s is formed around the electrode 14.

The open end (in other words, the connection port) of the measurement compartment 13 has a diameter D that allows an area S of the connection port to be larger than a surface area Sd of the spherical diffusion region 14s. When the area S of the connection port is smaller than the surface area Sd of the spherical diffusion region 14s, the diffusion at such a smaller connection port determines the rate of diffusion to the electrode 14, reducing the current value at the electrode 14. The surface area Sd of the diffusion region 14s is calculated using the formula below.

Sd=4π·((Ds/2)**2)/2

In this formula, Ds is the diameter of the spherical diffusion region 14s, and **2 indicates the square. The diameter D of the connection port is to satisfy the formula below.

π·((D/2)**2)>2π·((Ds/2)**2)

The diameter D of the connection port is thus to be greater than the diameter Ds of the spherical diffusion region 14s multiplied by the square root of 2. The measurement compartment 13 has a height H greater than or equal to the diameter D. The reasons for this will be described later. The diameter D of the connection port may be in the range of 1.5 μm to 3 cm on an empirical basis under the conditions of the present embodiment. The area S of the connection port may be in the range of 3.5 μm² to 5 cm² on an empirical basis, for both a circular connection port and a non-circular connection port.

Computational simulations indicate that the diameter Ds of the diffusion region 14s is substantially 1.6 times the diameter De of the electrode 14. This simulation result is consistent with data from our various experiments. The diffusion region 14s has no clear boundary, but rather the concentration of the analyte “a” increases gradually toward the substrate concentration “c” at positions farther from the electrode 14. The diameter Ds of the diffusion region 14s is calculated as described below. First, the slope (concentration gradient) of the concentration increase of the analyte “a” is determined at the surface of the electrode 14 by computational simulations. The distance by which the concentration of the analyte “a” increases from 0% at the surface of the electrode 14 to the substrate concentration “c” with the c oncentration gradient is calculated. The distance is determined as the radius of the diffusion region 14s. The diameter Ds of the diffusion region 14s is thus determined.

The above formula for calculating the surface area Sd is substituted into the formula below.

Ds=1.6·De

The resultant formula can be rewritten to obtain the formula below.

Sd=5.12·Se

In this formula, Se is the surface area of the electrode 14 (=π·(De/2)**2).

As described above, the opening area S of the connection port is to be larger than at least the surface area Sd of the diffusion region 14s. The surface area Sd is about 5 times the surface area Se of the electrode 14. The opening area S of the connection port may thus be about 5 times the surface area Se of the electrode 14 (in other words, the diameter D of the connection port may be about 2.3 times the diameter De of the electrode 14). With the diameter Ds of the diffusion region 14s being underestimated, the opening area S of the connection port may also be about 10 times the surface area Se of the electrode 14 (in other words, the diameter D of the connection port may be about 5 times the diameter De of the electrode 14).

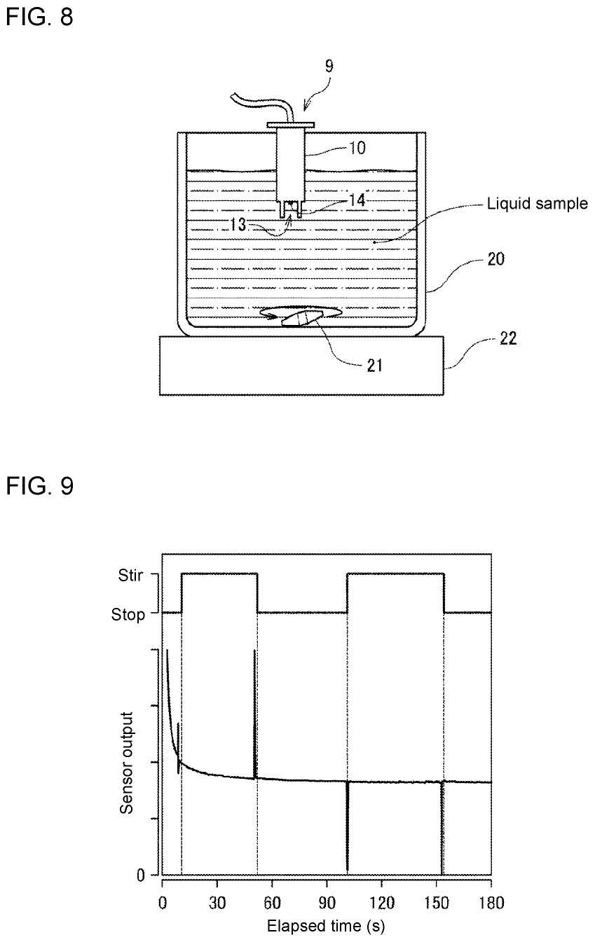

Such a biosensor 1 according to the first embodiment was used to conduct experiments similar to the above experiments using the biosensor 9 in the comparative example, and the effect of a flow of the liquid sample on the sensor output was evaluated. More specifically, as shown in FIG. 8, the distal end of the biosensor 1 was placed in the liquid sample in the container 20 to fill the measurement compartment 13 with the liquid sample. In this state, the output of the biosensor 1 was measured while stirring of the liquid sample with the stirrer 22 was performed or stopped.

FIG. 9 is a graph illustrating the obtained experimental results. The sensor output decreased rapidly when the biosensor 1 was placed into the liquid sample, as in the experimental results in FIG. 5 described above. The liquid sample started to be stirred during the decrease in the sensor output (specifically, about 10 seconds after the biosensor 1 was placed into the liquid sample). Although stirring was started during the decrease in the sensor output, the sensor output continued to decrease and then stabilized, without fluctuating during the stirring. Further, the sensor output remained stable despite repeated subsequent stops and starts of stirring. These experimental results suggest that the biosensor 1 according to the first embodiment can measure the concentration of the analyte “a” without being affected by a flow of the liquid sample. This may be because the liquid sample in the measurement compartment 13 is substantially unaffected by a flow in the liquid sample and thus the spherical diffusion region 14s can be formed around the electrode 14 in the measurement compartment 13.

Despite the particularly simple structure as shown in FIG. 1 or FIG. 7, the measurement compartment 13 in the biosensor 1 according to the first embodiment has notable advantages as shown in FIG. 9. This may result from the hydrodynamic mechanism associated with the small size of the electrode 14. This will be described below.

All liquids have mass and viscosity. A flow of a liquid is thus known to be affected by the inertial force caused by to the mass of the liquid and its viscosity. A Reynolds number Re is known as an index of the magnitude of the effects of the inertial force and viscosity. The Reynolds number Re is a dimensionless number calculated using the formula below. A larger Reynolds number Re indicates a greater effect of the inertial force, and a smaller Reynolds number Re indicates a greater effect of viscosity.

Re=(flow velocity U)·(characteristic length L)/(kinematic viscosity v of liquid)

In this formula, the characteristic length L refers to a dimension that characterizes a flow. For a flow in a pipe, for example, the characteristic length L is the inner diameter of the pipe. For a flow in the measurement compartment 13 in the biosensor 1 according to the first embodiment, the characteristic length L is the diameter D or the height H shown in FIG. 7.

In the biosensor 1 according to the first embodiment, the measurement compartment 13 may be small to accommodate the small electrode 14. The diameter D or the height H shown in FIG. 7 may thus be as small as about several millimeters. When the flow velocity of the liquid sample is expected to be about several millimeters or less per second, the Reynolds number Re ranges from a single-digit number to a two-digit number. A flow having a single-digit to two-digit Reynolds number Re is almost entirely dominated by viscosity, like a flow of honey. Without the measurement compartment 13, the dimension that characterizes a flow (characteristic length L) is, for example, the dimension of the container 20. In this case, the Reynolds number Re is expected to be about two orders of magnitude larger. With the Reynolds number Re about two orders of magnitude larger, the flow is much more affected by the inertial force.

Based on the above, the notable advantages of the biosensor 1 according to the first embodiment shown in FIG. 9 may result from the hydrodynamic mechanism described below. At positions farther from the protruding wall 12, the flow of the liquid sample has a larger Reynolds number Re, indicating that the flow is more affected by the inertial force and that the liquid sample tends to continue flowing. At positions closer to the protruding wall 12, the flow of the liquid sample has a sufficiently small Reynolds number Re, indicating a viscous flow. The flow of the liquid sample thus rapidly decelerates toward the protruding wall 12, forming a region with substantially no flow around the protruding wall 12. The liquid sample inside the measurement compartment 13 is thus less likely to be affected by a flow of the liquid sample outside the measurement compartment 13. When the electrode 14 has a larger diameter (e.g., about several millimeters), the flow does not decelerate largely near the protruding wall 12 and may affect the inside of the measurement compartment 13. In this case, the sensor output is expected to undergo large fluctuations. The protruding wall 12 thus functions as a deceleration member (deceleration wall) that allows formation of a region (deceleration region) in which the flow of the liquid sample decelerates outside the measurement compartment 13, in addition to separating a space around the electrode 14 as the measurement compartment 13 from a large space. The protruding wall 12 protruding from the position around the electrode 14 may be replaced by any other structure that can separate the space around the electrode 14 as the measurement compartment 13 and that can also decelerate the flow of the liquid sample. For example, the protruding wall 12 may be replaced by a plate located at a predetermined distance above the electrode 14 to define the measurement compartment 13 below the plate. Such a plate located at an appropriate distance from the electrode 14 can function as the deceleration member in place of the protruding wall 12.

To examine the effect of the shape of the measurement compartment 13 (specifically, the combination of the diameter D and the height H shown in FIG. 7) on the stability of the sensor output, the experiments described below were conducted. To quantify the stability of the sensor output, a sensor-output increase rate was used as an index of the stability. The sensor-output increase rate refers to the rate at which the sensor output is increased by stirring of the liquid sample relative to the sensor output obtained before the stirring. The sensor-output increase rate was calculated for various combinations of the diameter D and the height H of the measurement compartment 13.

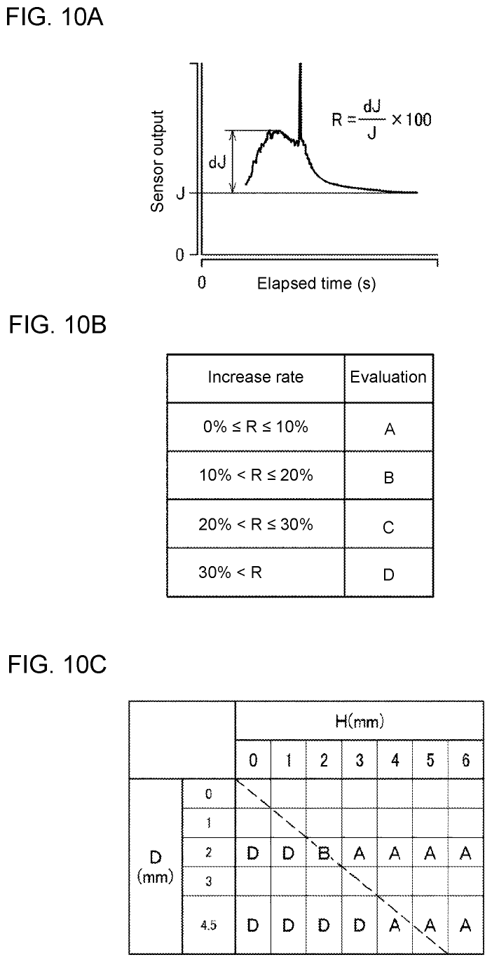

FIGS. 10A, 10B, and 10C are a graph and tables illustrating the obtained experimental results. FIG. 10A shows a formula for calculating a sensor-output increase rate R. The increase rate R was calculated by dividing an increase amount dJ of the sensor output resulting from stirring by a sensor output J obtained before stirring, and by multiplying the resultant value by 100. To determine the overall trend of the effect of the shape of the measurement compartment 13 on the increase rate R, the increase rate R was evaluated at four levels. As shown in FIG. 10B, the four levels used for evaluation were a level A indicating an increase rate R less than or equal to 10%, a level B indicating an increase rate R greater than 10% and less than or equal to 20%, a level C indicating an increase rate R greater than 20% and less than or equal to 30%, and a level D indicating an increase rate R greater than 30%. In the experiments, as shown in FIG. 10C, the sensor-output increase rate R was calculated for measurement compartments 13 with diameters D of 2 and 4.5 mm and with the heights H ranging from 0 to 6 mm in increments of 1 mm for each diameter D. In FIG. 10C, the diagonal dashed line indicates the conditions that the diameter D and the height H of the measurement compartment 13 are equal.

As shown in FIG. 10C, the experiment results are the level D in the section below and to the left of the dashed line (in other words, under the condition that the height H is less than the diameter D), and are the level A in the section above and to the right of the dashed line (in other words, under the condition that the height H is greater than the diameter D). Thus, the height H of the measurement compartment 13 may be greater than or equal to the diameter D, or more specifically, greater than or equal to 1.5 times the diameter D.

Although FIG. 10C shows experimental results obtained for a cylindrical measurement compartment 13, the measurement compartment 13 may be prismatic. In this case, the dimension of the measurement compartment 13 corresponding to the diameter D may be used. More specifically, the diameter of a circle having the same area value as the bottom surface of the prismatic measurement compartment 13 may be calculated, and the diameter may be used in place of the diameter D.

As described in detail above, the biosensor 1 according to the first embodiment uses the spherical diffusion region 14s formed around the electrode 14, in place of the permeability control layer found in any typical biosensor. This can eliminate issues associated with the permeability control layer (specifically, the issues of the biosensor involving calibration of the sensor output and having largely restricted use conditions). When the biosensor 1 is used in a flowing liquid sample, the electrode 14 mounted in the measurement compartment 13 is less likely to be affected by the flow. This allows accurate measurement of the concentration of the analyte “a” in the liquid sample.

The biosensor 1 according to the first embodiment described above may be modified variously. For example, in the biosensor 1 according to the first embodiment, the measurement compartment 13 is defined by the cylindrical protruding wall 12 protruding from the insertion portion 10 as described above with reference to FIGS. 1 and 7. However, the measurement compartment 13 may be defined by a cylindrical recess at the distal end of the insertion portion 10.

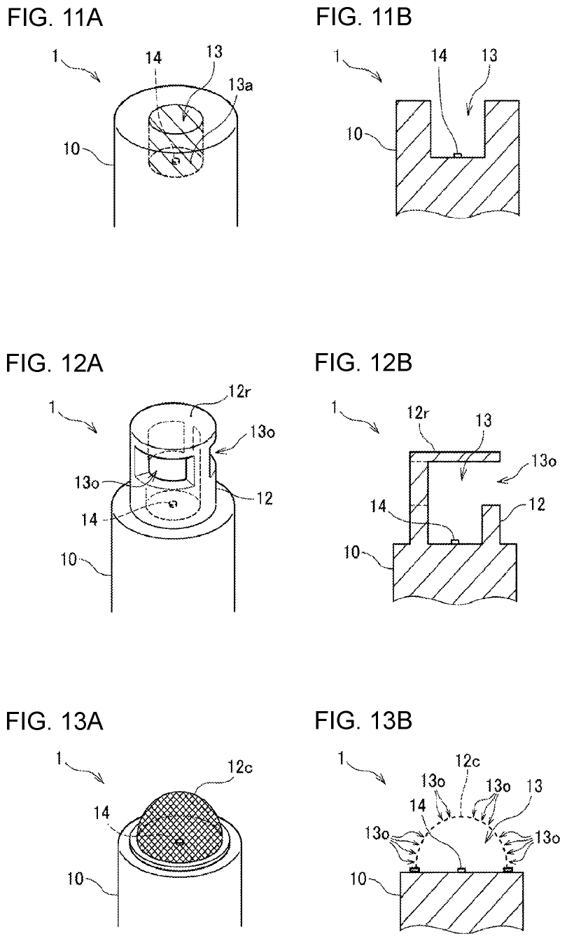

FIGS. 11A and 11B are diagrams of such a biosensor 1 according to a first modification of the first embodiment. FIG. 11A shows the exterior of a distal end portion of the biosensor 1 according to the first modification. FIG. 11B shows the cross-sectional profile of the distal end portion. The recess defining the measurement compartment 13 may be located on the side surface of the insertion portion 10. The biosensor 1 according to the first modification eliminates calibration, reduces restrictions on the use conditions, and is unaffected by a flow of the liquid sample by the same mechanism as the biosensor 1 according to the first embodiment described above.

In the biosensor 1 according to the first embodiment described above, the measurement compartment 13 is open at one end, and the liquid sample flows into the measurement compartment 13 through the open end when the biosensor 1 is placed in the liquid sample. However, the measurement compartment 13 may be closed by a ceiling 12r at the end, and the protruding wall 12 may have multiple connection ports 13o.

FIGS. 12A and 12B are diagrams of such a biosensor 1 according to a second modification of the first embodiment. FIG. 12A shows the exterior of a distal end portion of the biosensor 1 according to the second modification. FIG. 12B shows the cross-sectional profile of the distal end portion. In the second modification illustrated in FIGS. 12A and 12B, the protruding wall 12 has three connection ports 13o. The sum of the opening areas of the connection ports 13o is larger than the surface area Sd of the spherical diffusion region 14s formed around the electrode 14. When the biosensor 1 according to the second modification is placed in the liquid sample, the liquid sample flows into the measurement compartment 13 through the multiple connection ports 13o and forms the spherical diffusion region 14s around the electrode 14. The biosensor 1 thus eliminates calibration, reduces restrictions on the use conditions, and is unaffected by a flow of the liquid sample by the same mechanism as the biosensor 1 according to the first embodiment described above.

In the biosensor 1 according to the first embodiment, the measurement compartment 13 is defined by the protruding wall 12. However, the measurement compartment 13 may be defined by a domed cover 12c covering the electrode 14. The cover 12c may be formed from a sheet with countless small holes, such as a wire mesh, a mesh member, or a punched metal.

FIGS. 13A and 13B are diagrams of such a biosensor 1 according to a third modification of the first embodiment. FIG. 13A shows the exterior of a distal end portion of the biosensor 1 according to the third modification, with the cover 12c formed from a wire mesh. FIG. 13B shows the cross-sectional profile of a distal end portion of the biosensor 1 according to the third modification, with the cover 12c formed from a punched metal. In both cases, the cover 12c defines the measurement compartment 13. When the biosensor 1 according to the third modification is placed in the liquid sample, the liquid sample flows into the cover 12c through openings in the wire mesh, openings in the mesh member, or small holes in the punched metal and fills the measurement compartment 13. This causes formation of the spherical diffusion region 14s around the electrode 14. Portions of the cover 12c through which the liquid sample passes, or specifically, for example, the openings in the wire mesh, the openings in the mesh member, or the small holes in the punched metal, each correspond to the connection port 13o (refer to FIGS. 12A and 12B) in the second modification. The sum of the areas of the multiple connection ports 13o is larger than the surface area Sd of the spherical diffusion region 14s formed around the electrode 14. The biosensor 1 according to the third modification eliminates calibration, reduces restrictions on the use conditions, and is unaffected by a flow of the liquid sample by the same mechanism as the biosensor 1 according to the first embodiment described above.

### B. Second Embodiment

In the biosensor 1 according to the first embodiment or the biosensor 1 according to each modification of the first embodiment described above, the spherical diffusion region 14s formed around the electrode 14 is not in contact with the inner surface of the member defining the measurement compartment 13 (e.g., the protruding wall 12, the ceiling 12r, or the cover 12c). However, the diffusion region 14s formed around the electrode 14 may be in contact with the inner surface of the member defining the measurement compartment 13.

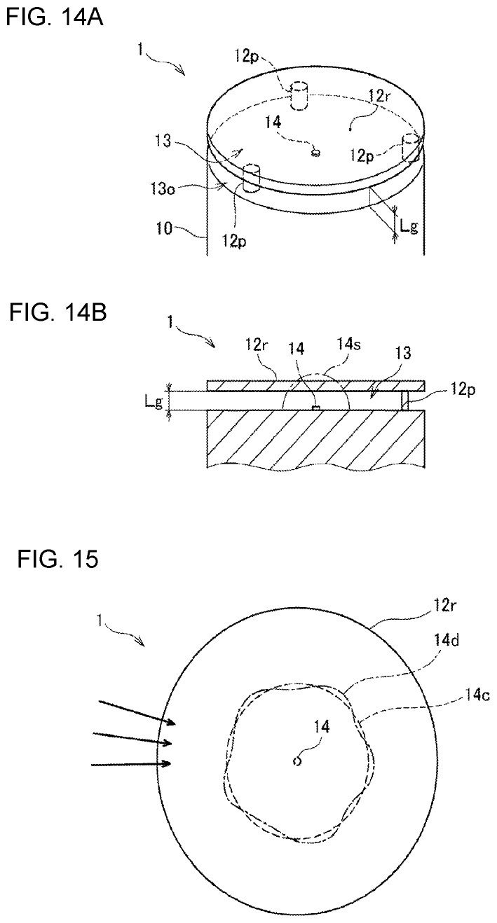

FIGS. 14A and 14B are diagrams of such a biosensor 1 according to a second embodiment in which the diffusion region 14s formed around the electrode 14 is in contact with the inner surface of the member defining the measurement compartment 13. FIG. 14A shows the exterior of a distal end portion of the biosensor 1 according to the second embodiment. FIG. 14B shows the cross-sectional profile of the distal end portion. As illustrated, the biosensor 1 according to the second embodiment includes a disk-shaped ceiling 12r attached to the distal end of the cylindrical insertion portion 10, with a gap having a dimension Lg between the ceiling 12r and the distal end of the insertion portion 10. The distal end of the insertion portion 10 and the ceiling 12r define the measurement compartment 13. The electrode 14 is mounted at the center of the distal end of the insertion portion 10. In the example shown in FIGS. 14A and 14B, the ceiling 12r is supported by three thin support posts 12p. However, the ceiling 12r may be supported by another structure. In FIGS. 14A and 14B, the insertion portion 10 is cylindrical, and the ceiling 12r is disk-shaped. However, these components may have any other shapes. For example, the insertion portion 10 may be prismatic, and the ceiling 12r may be a polygonal plate.

When the biosensor 1 according to the second embodiment is placed in the liquid sample, the liquid sample flows through the gap between the distal end of the insertion portion 10 and the ceiling 12r and fills the measurement compartment 13. In the biosensor 1 according to the second embodiment, the outer peripheral surface of the measurement compartment 13 defined between the insertion portion 10 and the ceiling 12 r serves as a connection port 13o.

The gap Lg between the insertion portion 10 and the ceiling 12r is smaller than the radius of a spherical diffusion region 14s (indicated by the dot-dash line in FIG. 14B) that may be formed around the electrode 14 without the ceiling 12r. The diffusion region around the electrode 14 comes in contact with the ceiling 12r before forming into a sphere and then grows in the radial direction of the ceiling 12r. The diffusion region thus forms into a disk-shaped region with a thickness Lg in the measurement compartment 13. The ceiling 12r and the insertion portion 10 each have a radius sufficiently larger than the radius of the disk-shaped diffusion region. The biosensor 1 according to the second embodiment is also less likely to be affected by a flow of the liquid sample for the reasons described below.

FIG. 15 is a diagram of the biosensor 1 according to the second embodiment, illustrating the reasons for which the biosensor 1 is less likely to be affected by a flow of the liquid sample. As described above with reference to FIGS. 14A and 14B, when the biosensor 1 according to the second embodiment is placed in the liquid sample, a disk-shaped diffusion region 14c is formed in the gap between the insertion portion 10 and the ceiling 12r (in other words, in the measurement compartment 13). The dashed circle in FIG. 15 indicates the shape of the diffusion region 14c as viewed from a position facing the distal end of the biosensor 1.

The dimension Lg of the gap between the insertion portion 10 and the ceiling 12r is smaller than the radius of the spherical diffusion region 14s, and is thus smaller than the height H of the measurement compartment 13 in the first embodiment (refer to FIG. 7) described above. Thus, the Reynolds number Re calculated using the gap Lg between the insertion portion 10 and the ceiling 12r as the characteristic length L is smaller than the Reynolds number Re for a flow around the protruding wall 12 in the first embodiment. This indicates that the flow in the gap between the insertion portion 10 and the ceiling 12r in the second embodiment is more affected by viscosity than the flow around the protruding wall 12 in the first embodiment. A flow in the liquid sample thus decelerates rapidly when entering through the gap between the insertion portion 10 and the ceiling 12r. Such a flow has only a minor effect on the diffusion region 14c formed in the measurement compartment 13. The solid arrows in FIG. 15 conceptually show the rapid deceleration of a flow entering through the gap between the insertion portion 10 and the ceiling 12r. The shape outlined by the dot-dash line in FIG. 15 conceptually shows the diffusion region 14d deformed under the effect of the flow entering through the gap. As compared with the diffusion region 14d, the diffusion region 14c undergoes only a minor deformation. Such a minor deformation does not largely increase the rate of diffusion of the analyte “a” to the electrode 14, unlike the case in FIG. 6 described above. The biosensor 1 according to the second embodiment thus also eliminates calibration, reduces restrictions on the use conditions, and is substantially unaffected by a flow of the liquid sample.

### C. Third Embodiment

In the biosensor 1 according to each of the first embodiment and the second embodiment described above, the opening area of the connection port 13o for the measurement compartment 13 is larger than the surface area Sd of the spherical diffusion region 14s formed around the electrode 14. However, the opening area of the connection port 13o may be smaller than the surface area Sd of the spherical diffusion region 14s.

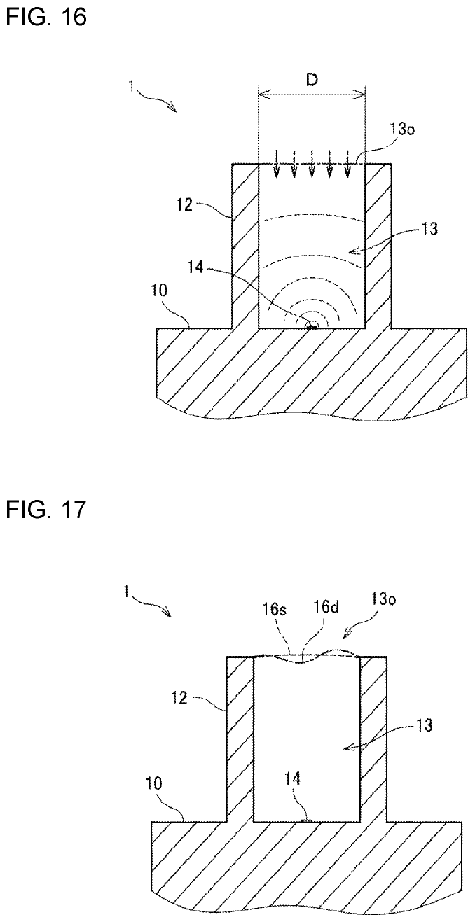

FIG. 16 is a diagram of a biosensor 1 according to a third embodiment, illustrating the cross-sectional profile of its distal end portion. The biosensor 1 according to the third embodiment differs from the biosensor 1 according to the first embodiment described above with reference to FIG. 7 only in that the biosensor 1 according to the third embodiment has a smaller inner diameter D of the protruding wall 12. Thus, in the third embodiment, the area of the connection port 13o for the measurement compartment 13 (the open end of the measurement compartment 13) is smaller than the surface area Sd of the spherical diffusion region 14s formed around the electrode 14 in the liquid sample.

In the biosensor 1 according to the third embodiment, the rate at which the analyte “a” is supplied to the electrode 14 is determined by the rate at which the analyte “a” diffuses through the connection port 13°. In the biosensor 1 according to the third embodiment, the rate at which the analyte “a” is supplied to the electrode 14 is thus determined by the connection port 13o for the measurement compartment 13, rather than being determined by the diffusion region around the electrode 14 as in the biosensor 1 according to each of the first embodiment and the second embodiment described above. The structure in the third embodiment advantageously reduces the effect of a flow on the sensor output, although also having an issue of decrease in the current value of the current generated at the electrode 14 (in other words, the sensor output). The reasons for this will be described below.

The concentration of the analyte “a” in the liquid sample in which the biosensor 1 is placed is a constant concentration (substrate concentration “c”). While a limited amount of the analyte “a” is supplied into the measurement compartment 13 through the connection port 13o, the electrode 14 converts the analyte “a” rapidly in the measurement compartment 13. The rate at which the analyte “a” is decomposed by the enzyme on the electrode 14 may be sufficiently high, and thus the concentration of the analyte “a” is zero at the position of the electrode 14. The measurement compartment 13 may thus have a concentration gradient ranging from the substrate concentration “c” at the connection port 13o to zero at the position of the electrode 14. The rate at which the analyte “a” is supplied to the electrode 14, or in other words, the rate at which the analyte “a” flows into the measurement compartment 13 through the connection port 13°, is determined by the substrate concentration “c” of the analyte “a” and by the distance from the connection port 13o to the electrode 14 (the path length of the measurement compartment 13). The current value at the electrode 14 is thus determined by the substrate concentration “c” of the analyte “a”, the distance from the connection port 13o to the electrode 14, and the area of the connection port 13°. The biosensor 1 according to the third embodiment shown in FIG. 16 is thus not largely affected by a flow of the liquid sample, unlike the case in FIG. 6. The connection port 13o may have a diameter greater than or equal to 10 μm. When the diameter of the connection port 13o is too small, the inner wall surface of the measurement compartment 13 may cause an adverse effect.

With a flow in the liquid sample through the connection port 13o, the flow promotes the diffusion through the connection port 13o into the measurement compartment 13 and may have a certain effect on the output of the electrode 14. Such an effect can be identified using the models described below. In an example model, the connection port 13o has a boundary surface 16s through which the analyte “a” passes toward the measurement compartment 13. In this model, the boundary surface 16s deforms and increases its area in response to a flow in the liquid sample through the connection port 13o, thus increasing the output of the electrode 14.

FIG. 17 conceptually shows deformation of the boundary surface of the connection port 13o under the effect of a flow in the liquid sample. In FIG. 17, the dashed line indicates the boundary surface 16s with no deformation, and the dot-dash line indicates a deformed boundary surface 16d. Since the boundary surface is formed at the connection port 13o, the radially outer circumference of the boundary surface formed at the connection port 13o is at a fixed position regardless of whether the boundary surface is deformed. The area of the boundary surface thus does not change largely when the boundary surface deforms in response to a flow in the liquid sample. In another example model, a flow promotes diffusion through the connection port 13o into the measurement compartment 13 and increases the concentration of the analyte “a” near the inlet of the measurement compartment 13. This causes the region with the substrate concentration “c” to appear to spread slightly into the measurement compartment 13, thus increasing the output of the electrode 14. In this model, the region with the substrate concentration “c” is less likely to spread into the measurement compartment 13 largely through the connection port 13o having the small area. In any of the above models, the rate at which the analyte “a” is supplied to the electrode 14 is not largely changed by a flow in the liquid sample, and fluctuations of the sensor output can be greatly reduced.

The biosensor 1 according to the third embodiment reduces the rate at which the analyte “a” is supplied to the electrode 14, thus also having an issue of decrease in the sensor output. To address this, a type of analyte “a” that releases a large number of electrons “n” when converted at the electrode 14 may be selected as appropriate. A combination of the liquid sample and the analyte “a” that has a large diffusion coefficient Kd of the analyte “a” may also be selected as appropriate. Further, a temperature of the liquid sample may also be increased to increase the diffusion coefficient Kd. Such adjustment can increase the sensor output and can address the above issues. The biosensor 1 according to the third embodiment thus eliminates calibration, reduces restrictions on the use conditions, and is unaffected by a flow of the liquid sample by the same mechanism as the biosensor 1 according to the first embodiment described above.

The biosensor 1 according to the third embodiment described above combines the biosensor 1 according to the first embodiment with the concept that the rate at which the analyte “a” is supplied to the electrode 14 is determined by the area of the connection port 13o for the measurement compartment 13. However, the biosensor 1 according to the third embodiment may combine the concept with the biosensor 1 according to any of the modifications of the first embodiment or the second embodiment, in place of the biosensor 1 according to the first embodiment. In these cases, the biosensor 1 also eliminates calibration, reduces restrictions on the use conditions, and is unaffected by a flow of the liquid sample.

The biosensor 1 according to any of the above embodiments and modifications may be used to measure the concentration of a component in a liquid sample flowing through a device with microfluidic channels, which is called a microfluidic device. In this case, the electrode 14 may have a diameter less than or equal to 1 mm (more specifically, less than or equal to 0.1 mm) and the height H less than or equal to 1 mm.

The biosensor 1 according to any of the above embodiments and modifications may be used to monitor or manage the progress of various reactions. The biosensor 1 according to any of the above embodiments and modifications may thus be included in a stirred reactor.

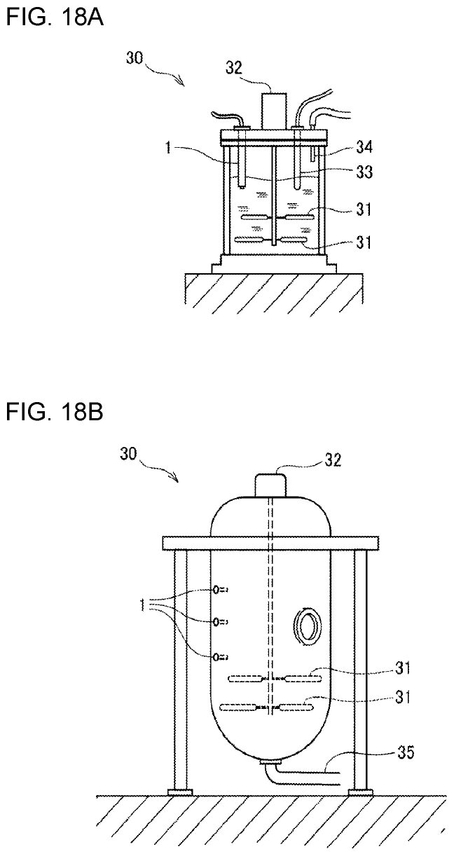

FIGS. 18A and 18B are diagrams of example stirred reactors 30 each including the biosensor 1. FIG. 18A illustrates a stirred reactor 30 for reacting about several liters of liquid. FIG. 18B illustrates a stirred reactor 30 for reacting about 100 liters of liquid. The stirred reactor 30 may be larger.

As illustrated in FIG. 18A or FIG. 18B, the stirred reactor 30 includes impellers 31 for promoting reactions for uniformity in the stirred reactor 30 and a stirring motor 32 for rotating the impellers 31. A small stirred reactor 30 as illustrated in FIG. 18A may include, for example, a stirrer in place of the impellers 31. The stirred reactor 30 may also include a heater 33 for controlling reactions and an inlet port 34 for chemical solutions. A large stirred reactor 30 as illustrated in FIG. 18B may include a discharge channel 35 for discharging products after the reaction. Any of such stirred reactors 30 may include one or more biosensors 1. The biosensors 1 can detect the concentration of the analyte “a” stably and accurately while the liquid sample is stirred by the impellers 31 in the stirred reactor 30. This allows accurate and real-time monitoring of the progress of reactions and allows appropriate management of reactions.

The biosensor 1 according to various embodiments and modifications has been described. However, the present invention is not limited to the above embodiments and modifications and may be implemented in various manners without departing from the spirit and scope of the invention.

### REFERENCE SIGNS LIST

1 biosensor
10 insertion portion
11 flange
12 protruding wall
12c cover
12p support post
12r ceiling
13 measurement compartment
13a bottom surface
13o connection port
14 electrode
14c, 14d, 14s diffusion region
14z enzyme
15 lead wire
15a electric wire
16d, 16s boundary surface
20 container
21 rotor
22 stirrer
30 stirred reactor
31 impeller 31
32 stirring motor 32
33 heater 33
34 inlet port 34
35 discharge channel

1. A biosensor for measuring a concentration of a predetermined analyte in a liquid sample by converting the analyte to a substance different from the analyte with an enzyme immobilized on an electrode and by detecting an electric signal generated at the electrode by conversion of the analyte, the biosensor comprising:
an insertion portion placeable in the liquid sample,
the insertion portion including a measurement compartment fillable with the liquid sample flowing into the measurement compartment when the insertion portion is placed in the liquid sample,
the electrode being mounted in the measurement compartment, with the enzyme being immobilized on the electrode to be in contact with the liquid sample when the measurement compartment is filled with the liquid sample.

2. The biosensor according to claim 1, wherein
the measurement compartment is cylindrical or prismatic and is open at one end and closed at a bottom, and
the electrode is mounted on a bottom surface of the cylindrical or prismatic measurement compartment.

3. The biosensor according to claim 2, wherein
the measurement compartment is defined by a protruding wall protruding from a position around the electrode and surrounding a space around the electrode.

4. The biosensor according to claim 2, wherein
the measurement compartment has a height greater than or equal to a diameter of a circle having a same area as the bottom surface of the cylindrical or prismatic measurement compartment.

5. A stirred reactor, comprising:
the biosensor according to claim 1.

6. A stirred reactor, comprising:
the biosensor according to claim 2.

7. A stirred reactor, comprising:
the biosensor according to claim 3.

8. A stirred reactor, comprising:
the biosensor according to claim 4.

9. The biosensor according to claim 3, wherein
the measurement compartment has a height greater than or equal to a diameter of a circle having a same area as the bottom surface of the cylindrical or prismatic measurement compartment.

10. A stirred reactor, comprising:
the biosensor according to claim 9.
